(19) United States
(12) Patent Application Publication
(10) Pub. No.: US 2005/0035628 A1
(43) Pub. Date: Feb. 17, 2005

(54) Cast carrier element for a vehicle body

(76) Inventors: Thomas Behr, Elchingen (DE); Konrad Eipper, Rottenburg (DE); Wolfgang Fussnegger, Tuebingen (DE); Arndt Gerick, Ulm (DE); Wolfgang Kleinekathoefer, Waldstetten (DE); Daniel Minnich, Ulm (DE); Mattias Scheffzuek, Tuebingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/491,626

(22) PCT Filed: Sep. 17, 2002
(86) PCT No.: PCT/EP02/10408

(30) Foreign Application Priority Data
Oct. 5, 2001 (DE) 101 49 244.8

(51) Int. Cl. B62D 25/04

(52) U.S. Cl. 296/187.02

(57) ABSTRACT

The invention relates to a support element for a vehicle body, in particular for supporting columns, the support element being produced from cast iron. The support element is designed, for example, as a lattice structure and is filled with metallic hollow balls for additional reinforcement.

### BACKGROUND AND SUMMARY OF THE INVENTION

The present invention relates to a support element for a vehicle body and to a method of producing a support element.

Support elements of vehicle bodies are as a rule composed of metal sheets of constant wall thickness. These sheets are often formed into half shells and a plurality of half shells are welded to form a support element or structure element. In the case of the A-columns of motor vehicles, in particular of convertibles, the strength of the support element in the event of overturning is often not high enough in order to ensure a sufficient survival space for the occupants.

To ensure crash safety, the roof columns, in particular the A-columns of convertibles, are reinforced with a steel tube which runs in the center of the column. Such an A-column establishing the generic type is described in German publication DE 40 16 730 C2.

In the course of extensive attempts to achieve lightweight construction in automobile manufacture, efforts are increasingly being made to also save weight in load-bearing parts. Shown in a journal article (mot September 2001, page 64) is a study of a vehicle having an A-column which comprises two struts which are connected via a two-dimensional zigzag profile. Although this type of construction offers a high potential for saving weight, crash safety is not ensured by this simple zigzag structure, since it has no suitable reinforcement in particular for a side collision.

An object of this invention is to provide a support element which has a lower weight compared with the prior art at the same or improved strength.

This object is achieved by the features of the claimed invention.

A support element according to the invention is produced from cast iron. An advantage compared with the conventional steel sheets used in vehicle body construction is that, in structures of cast iron, the material thickness can be adapted to the forces which occur. It is thus possible by means of loading simulations to determine the regions with the highest mechanical loads and to reinforce the material in these regions. On the other hand, in regions subjected to low load, material can be saved. By optimizing these methods, a weight saving of over 50% compared with a steel sheet construction can be achieved in a support element having the same function.

Compared with a construction of cast aluminum, the invention has an advantage in higher strength and greater elongation of the iron materials compared with the cast aluminum materials. By the described displacement of material and saving of material, support elements can be produced which, with the same function, have a mass similar to that of cast aluminum components, but can instead be mechanically loaded to a substantially greater extent.

The support element, in a cavity, is filled with a core of hollow balls or an iron-based metal foam (iron foam). The hollow balls or the iron foam, as core material, lead to an increase in mechanical strength, the weight of the support element increasing only marginally. In addition, the hollow balls help to improve the damping of body vibrations.

The support element may comprise at least one cast shell element which is produced essentially from struts. If the support element consists of a plurality of shell elements, they are joined together to form the support element and form a lattice structure which encloses a cavity. If one shell element is used, it can be identical to the support element. The cavity is enclosed by the lattice structure and has no closed surface as a rule. The struts of the support element are arranged in such a way that, during tensile loading of one strut, at least one corresponding strut is equally loaded in compression.

The support element preferably contains at least three longitudinal struts, which form the cavity. The longitudinal struts are connected by a plurality of transverse struts in such a way that in each case tensile loads and compressive loads are compensated for. As a rule, the transverse struts in each case run between adjacent longitudinal struts; however, they may also run through the cavity to opposite longitudinal struts if the mechanical stress requires this.

In a further embodiment, the support element is likewise composed of at least one shell element. This shell element has a surface which is closed over wide sections. The surface of the shell element is provided with struts in the direction of a concave arch of the shell element. The struts are preferably designed in the form of ribs. In this embodiment, for saving material, the surface may have very thin wall thicknesses or holes in regions subjected to low mechanical loading. This configuration of the invention functions in a way which is analogous to that of the lattice structure, so that, by means of the strutting in the cavity, a tensile load can be compensated for by an analogous compressive load.

At the surface or the struts or ribs, the support element preferably has a wall thickness which is less than 3 mm. Due to such wall thicknesses, the weight of the support element is reduced while ensuring sufficient strength.

The hollow balls are connected to one another, as a result of which their strength-increasing effect is increased even further.

A further essential part of the invention is a method for producing the support element according to the invention.

Accordingly, shell elements for producing the support element according to the invention are cast in a sand mold. The sand mold comprises a plurality of partial cores. At least one of the partial cores consists of metallic hollow balls or an iron foam. The sand mold is filled with an iron alloy, at least the one inner partial core being encapsulated by the iron alloy and remaining as reinforcing element in the support element.

To carry out the method according to the invention, various casting methods and heat-treatment methods are expedient. Preferred methods are the casting of cast steel, the casting of spheroidal graphite cast iron or the casting of malleable cast iron. Age hardening or heat treatments to form bainitically hardened iron or “austenitic ductile iron” (ADI) are likewise expedient.

Especially preferred embodiments are explained in more detail with reference to the drawing figures.

### BRIEF DESCRIPTION OF THE DRAWINGS

FIG. 1 shows a support element with a lattice structure,

FIG. 2 shows a support element with strutting in a cavity,

FIGS. 3a-3c show details from a surface of a support element with a hole structure,

FIG. 4 shows an enlarged detail of the support element from FIG. 1, filled with hollow balls, and

FIG. 5 shows a detail of the support element of FIG. 2, filled with hollow balls.

### DETAILED DESCRIPTION OF THE INVENTION

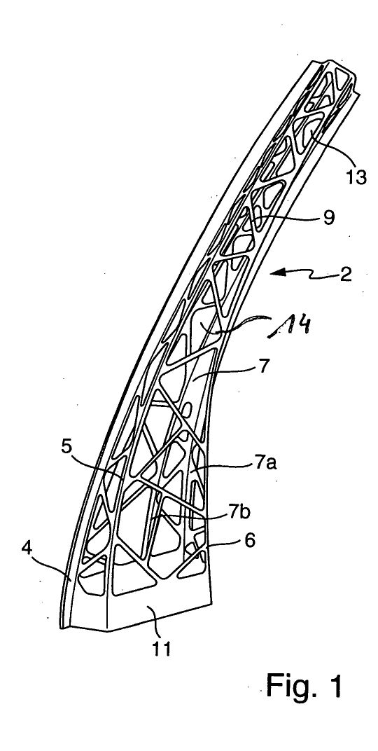

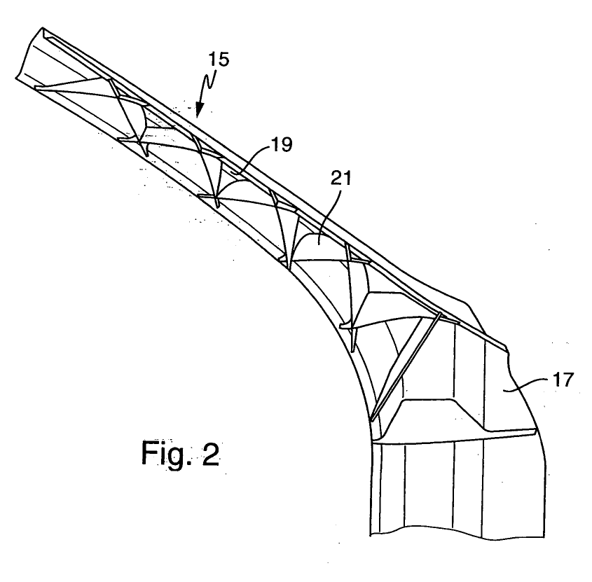

The support element 2 shown in FIG. 1 is designed in the form of an A-column of a motor vehicle. In order to more clearly show the support element, the hollow balls embedded according to the invention are not depicted in the support elements in FIGS. 1 and 2.

The support element in FIG. 1 has four longitudinal struts 4-7, the longitudinal strut 7 branching in the bottom region (7a and 7b). The support element 2 consists of a shell element, which in this case is identical to the support element 2. The longitudinal struts 4-7 and 7a, b are connected by transverse struts 9. The longitudinal struts 4-7, 7a, b and the transverse struts 9 together produce a lattice structure which forms the surface of the support element but is open in wide regions.

In the base region, the support element 2 has an encircling transverse strut 11 which is designed to be markedly wider than the other transverse struts 9. The transverse strut 11 is to be regarded as exemplary; likewise, in corresponding loading cases, the other longitudinal or transverse struts 4-7, 7a, b, 9, 13 are to be made wider or thicker. This possibly leads to the openings 13 in the lattice structure becoming correspondingly smaller. The lattice structure comprises a cavity 14.

When used in the motor vehicle, the support element 2 is as a rule provided with a skin. The skin may consist of thin metal sheets, planar plastic parts, glass or plexiglass panes. The advantage of using transparent materials is that the column is partly transparent, which helps to improve the field of view.

The half shell 15 shown in FIG. 2 is designed as part of an A-column. In this embodiment, it has a closed surface 17 which encloses a cavity 19 in a concave arch. Struts, which in FIG. 2 are designed as ribs 21, pass through the cavity 19 (here filled with hollow balls, which are not shown). The ribs 21 are in contact with the surface over their entire length. A second half shell (not shown here) can be used for the complete enclosure. However, the half shell 15 is also self-supporting on its own as support element.

A further advantage of the support elements according to FIGS. 1 and 2 with regard to the optimization of mass is that, compared with the conventional prior art, a central steel tube can be dispensed with. The reduction in mass, taking an A-column according to FIG. 1 as an example, is about 55% compared with an A-column of conventional design.

On account of the optimization of mass, the thickness of the surface and ribs of the support elements in FIG. 1 or 2 is preferably less than 3 mm. For mechanical reasons, however, it is necessary to ensure greater wall thicknesses at selected locations. To offset this, however, it is possible in particular in the case of half shells according to FIG. 2 to dispense with material at locations which are subjected to less loading. This means either thinner wall thicknesses or holes in the surface 17 or in the ribs 21.

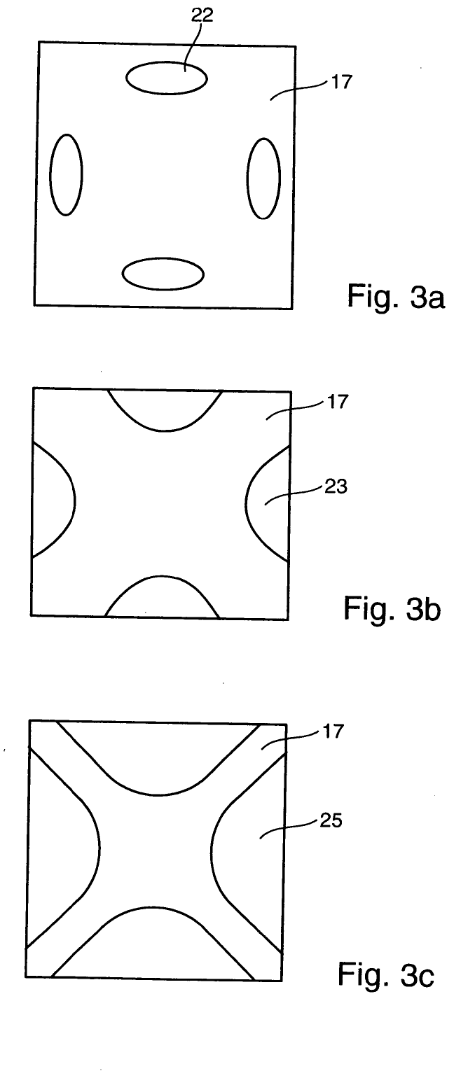

Such modifications of the surface 17 are shown by way of example in FIGS. 3a to 3c. The surface 17 has openings 22, 23, 25, as are revealed as surface details by said FIGS. 3a to 3c. The openings 22, 23, 25 serve in particular to reduce the mass. The size of the openings 22, 23, 25 increases from FIG. 3a to FIG. 3c. The special case of an—at least local—lattice structure is shown in FIG. 3c. In all cases, the strutting of the half shell 15 may also be effected in the form of struts (not shown here) analogous to FIG. 1. From the casting point of view, however, ribbing analogous to the ribs 21 is advantageous.

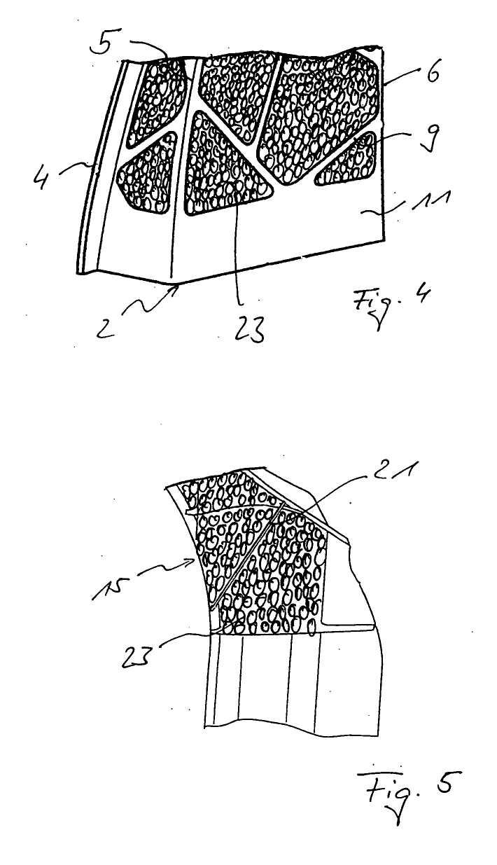

Details of the support elements 2 and 15 from FIGS. 1 and 2 are shown in FIGS. 4 and 5. In these illustrations, the support elements 2, 15 are filled with metallic hollow balls 23. An additional increase in strength is produced by the metallic hollow balls 23.

The hollow balls have a diameter of between 0.5 mm and 10 mm and are preferably packed very tightly in a cubic arrangement.

To increase the packing density, the hollow balls may be distributed in their diameter. A bimodal diameter distribution is preferably provided here.

It is likewise expedient to fill the cavity 19 with an iron-based metal foam.

A sand mold is produced in order to produce a support element according to the invention. Unlike a conventional sand mold, a core part which forms the cavity 19 is produced from hollow balls 23 or an iron foam. The support element is cast with an iron alloy and the outer sand mold is removed. The hollow balls remain in the cavity and serve to increase the rigidity of the support element.

A preferred method of casting the shell elements is the casting of cast steel, in particular by low-pressure die casting with very small wall thicknesses. The material has a low carbon proportion (below 2%) and can be tempered like cast steel if appropriately handled. Tensile strength values of over 450 N/mm² are achieved by cast steel; tempering steels can achieve up to 1000 N/mm².

A further preferred casting method is the casting of spheroidal graphite cast iron, what is referred to as nodular iron, which, like cast steel, is distinguished by a relatively high ductility and in the tempered state likewise achieves a tensile strength of 1000 N/mm². A further preferred casting method is low-pressure die casting.

The casting of “malleable cast iron” is likewise expedient for producing a support element according to the invention. By thermal treatments of about 900° C. and further chemical reactions with gases, carbon is extracted from the cast iron and the material is thus rendered ductile. Spheroidal graphite cast iron, for example, can be rendered ductile by “austenitic ductile iron”, the ADI process, which likewise requires an annealing process at about 900° C., which is followed by differentiated cooling to about 380° C., by means of which the desired structure formation, an intermediate stage structure of carbon-stabilized austenite and ferrite, is controlled.

All the casting methods are preferably carried out by sand casting with a lost core, as a result of which the cavity within the struts or the surface can be formed.

The support element has a further advantage in vehicles with special ballistic protection. The wall thickness can be varied by the comparatively small change to the cores or molds.

In this way, starting from the requirement for ballistic protection, the wall thickness can be specifically increased locally. This can be carried out directly in series production. The vehicle to be armored is equipped with the reinforced support element immediately upon assembly; subsequent dismantling is not required. In addition, expensive welding operations can be avoided. To this possibility of the support element according to the invention helps considerably to reduce the costs.

1-7. (Canceled)

8. A support element for a vehicle body, the support element being produced from cast iron and comprising at least one cast shell element which forms an outer contour of the support element and encloses a cavity, wherein the cavity is at least partly filled with a core of metallic hollow balls or iron-based metal foam, wherein a core stack which produces the support element in a negative form comprises a plurality of partial cores, wherein the partial cores include at least one inner partial core consisting of hollow balls or iron-based metal foam, wherein the support element is cast with an iron alloy, in particular in cast steel, spheroidal graphite cast iron or malleable cast iron, and wherein the inner partial core of hollow balls or iron-based metal foam is at least partly encapsulated by the iron alloy and remains in the support element after demolding.

9. The support element as claimed in claim 8, wherein the outer contour of the support element is in the form of a lattice structure.

10. The support element as claimed in claim 9, wherein the support element comprises at least three longitudinal struts which are connected to one another by transverse struts.

11. The support element as claimed in claim 8, wherein the shell element is reinforced in the cavity by strutting.

12. The support element as claimed in claim 8, wherein the support element has a wall thickness of less than 3 mm.

13. The support element as claimed in claim 8, wherein the cavity is at least partly filled with a core of metallic hollow balls, and wherein the metallic hollow balls are connected to one another.

14. The support element as claimed in claim 8, wherein the support element is a column.

15. The support element as claimed in claim 9, wherein the support element has a wall thickness of less than 3 mm.

16. The support element as claimed in claim 10, wherein the support element has a wall thickness of less than 3 mm.

17. The support element as claimed in claim 11, wherein the support element has a wall thickness of less than 3 mm.

18. The support element as claimed in claim 9, wherein the cavity is at least partly filled with a core of metallic hollow balls, and wherein the metallic hollow balls are connected to one another.

19. The support element as claimed in claim 10, wherein the cavity is at least partly filled with a core of metallic hollow balls, and wherein the metallic hollow balls are connected to one another.

20. The support element as claimed in claim 11, wherein the cavity is at least partly filled with a core of metallic hollow balls, and wherein the metallic hollow balls are connected to one another.

21. The support element as claimed in claim 12, wherein the cavity is at least partly filled with a core of metallic hollow balls, and wherein the metallic hollow balls are connected to one another.

22. The support element as claimed in claim 15, wherein the cavity is at least partly filled with a core of metallic hollow balls, and wherein the metallic hollow balls are connected to one another.

23. The support element as claimed in claim 16, wherein the cavity is at least partly filled with a core of metallic hollow balls, and wherein the metallic hollow balls are connected to one another.

24. The support element as claimed in claim 17, wherein the cavity is at least partly filled with a core of metallic hollow balls, and wherein the metallic hollow balls are connected to one another.
